(19) United States
(12) Patent Application Publication
(10) Pub. No.: US 2026/0097600 A1
(43) Pub. Date: Apr. 9, 2026

(54) RECORDING DEVICE

(71) Applicant: SEIKO EPSON CORPORATION, Tokyo (JP)

(72) Inventors: Hideaki NISHIJIMA, SHIOJIRI-SHI (JP); Yoshiyuki OKAZAWA, SHIOJIRI-SHI (JP); Tatsuya SHIRANE, SHIOJIRI-SHI (JP)

(21) Appl. No.: 19/348,932

(22) Filed: Oct. 3, 2025

(30) Foreign Application Priority Data
Oct. 7, 2024 (JP) 2024-176089

(51) Int. Cl. B41J 29/02; B41J 3/44; B41J 11/00; B41J 13/03; B41J 13/10; B41J 29/12; H04N 1/00

(52) U.S. Cl. CPC B41J 29/02; B41J 3/44; B41J 11/0095; B41J 13/03; B41J 13/103; B41J 29/12; H04N 1/00559; H04N 1/00795

(57) ABSTRACT

A recording device includes: a medium support section that supports a medium before feeding in an inclined posture; a feed roller that feeds the medium from the medium support section; a recording section that performs recording on the medium fed by the feed roller; a frame positioned between the medium support section and the recording section; and a board on which an electronic component is mounted. A first frame surface of the frame faces the feed roller, and a second frame surface opposite to the first frame surface faces the recording section. The board is provided such that a first side faces a first frame surface of the frame and a second side opposite to the first side is farther away from the frame than the first side.

The present application is based on, and claims priority from JP Application Serial Number 2024-176089, filed Oct. 7, 2024, the disclosure of which is hereby incorporated by reference herein in its entirety.

### BACKGROUND

### 1. Technical Field

The present disclosure relates to a recording device for recording on a medium.

### 2. Related Art

In a recording device represented by an inkjet printer, a circuit board is provided vertically on the back surface side of a main frame section, as shown in JP-A-2003-72039.

If it becomes necessary to increase the size of the circuit board in the recording device described in JP-A-2003-72039, it may be possible to extend the circuit board in the width direction or height direction of the device. However, since the components such as the carriage motor are provided on the back surface side of the main frame section, there is a limitation in extending the circuit board in the apparatus width direction. When the circuit board is extended in the height direction, the circuit board protrudes upward from the upper end of the main frame section, and therefore, the dimension of the device in the height direction increases.

### SUMMARY

To solve the above problem, a recording device of the present disclosure includes a medium support section that supports a medium before feeding in an inclined posture; a feed roller that feeds the medium from the medium support section; a recording section that performs recording on the medium fed by the feed roller; a frame positioned between the medium support section and the recording section; and a board on which an electronic component is mounted, wherein the frame has a first frame surface facing the feed roller and a second frame surface opposite from the first frame surface, the second frame surface faces the recording section, the board has a first side and a second side opposite from the first side, and the board is disposed such that the first side faces the first frame surface of the frame and the second side is farther from the frame than the first side in a direction intersecting the first frame surface.

### BRIEF DESCRIPTION OF THE DRAWINGS

FIG. 1 is an external perspective view of a printer.

FIG. 2 is an external perspective view of the printer with a document transport section opened.

FIG. 3 is an external perspective view of the printer with a scanner section opened.

FIG. 4 is an external perspective view of the printer in which the operation panel is tilted upward.

FIG. 5 is an external perspective view of the printer in a state where a medium receiving tray is pulled out and a medium support is opened.

FIG. 6 is a perspective view of a recording unit with a housing removed.

FIG. 7A is a plan view of the recording unit with the housing removed.

FIG. 7B is a diagram showing the positional relationship of some of the components in FIG. 7A.

FIG. 8A is a diagram illustrating a medium transport path in a recording unit.

FIG. 8B is a diagram showing the positional relationship of some of the components in FIG. 8A.

FIG. 8C is a diagram showing the positional relationship of some of the components in FIG. 8A.

FIG. 9 is a perspective view of a frame, a transport roller pair, a discharge roller pair, and a suction pump.

FIG. 10 is a perspective view of a frame, a main board, a shield plate, and a holder member.

FIG. 11 is a perspective view of the frame, the main board, the shield plate, and the holder member.

FIG. 12 is an exploded perspective view of the frame, the main board, the shield plate, and the holder member.

FIG. 13 is a perspective view of the frame to which the holder member is attached, the main board, and the shield plate.

FIG. 14 is a perspective view of a frame to which a holder member and a shield plate are attached, and a main board.

FIG. 15 is an enlarged perspective view of a portion where the shield plate and the board are fixed.

FIG. 16 is a perspective view of the main board and the holder member as viewed from below.

FIG. 17 is a perspective view of the holder member.

FIG. 18 is a view illustrating a portion where the main board is supported by the base section.

### DESCRIPTION OF EMBODIMENTS

Hereinafter, the present disclosure will be generally described.

A recording device according to a first aspect includes a medium support section that supports a medium before feeding in an inclined posture; a feed roller that feeds the medium from the medium support section; a recording section that performs recording on the medium fed by the feed roller; a frame positioned between the medium support section and the recording section; and a board on which an electronic component is mounted, wherein the frame has a first frame surface facing the feed roller and a second frame surface opposite from the first frame surface, the second frame surface faces the recording section, the board has a first side and a second side opposite from the first side, and the board is disposed such that the first side faces the first frame surface of the frame and the second side is farther from the frame than the first side in a direction intersecting the first frame surface.

In a configuration in which the medium support section supports the medium in an inclined position before feeding, and the frame is provided between the medium support section and the recording section, a space that expands upward is formed between the first frame surface of the frame and the medium support section. Hereinafter, this space is referred to as a space on the back side of the frame.

According to the present aspect, the board is provided such that the first side faces the first frame surface of the frame and the second side is farther from the frame than the first side in a direction intersecting the first frame surface. With this configuration, the board can be disposed by effectively using the space on the back side of the frame. This can suppress an increase in the size of the device due to the arrangement of the board.

For example, even if the board is increased in size in a direction in which the distance between the first side and the second side increases, the size of the device in the height direction is unlikely to increase. When the sides of the board intersecting the first side and the second side are a third side and a fourth side, even if the board is increased in size in a direction in which the distance between the third side and the fourth side increases, the size of the device in the height direction is similarly unlikely to increase.

Since the board is disposed such that the first side faces the first frame surface of the frame and the second side is farther from the frame than the first side in the direction intersecting the first frame surface, with this configuration, even when the board is increased in size in the direction in which the distance between the third side and the fourth side increases, the board and other components provided on the first frame surface are unlikely to interfere with each other.

As described above, according to the present aspect, even when the board is increased in size, it is possible to achieve a configuration in which an increase in the dimension of the device in the height direction is unlikely to occur.

A second aspect is an aspect according to the first aspect, wherein the board is disposed in a posture along a horizontal plane.

According to this aspect, since the board is disposed in a posture along the horizontal plane, the space on the back side of the frame can be more efficiently used.

A third aspect is an aspect according to the first aspect, wherein the board is disposed at a position that is above the feed roller and that overlaps the feed roller in plan view.

According to the present aspect, the board is disposed at a position that is above the feed roller and that overlaps the feed roller in plan view. This configuration allows a region above the feed roller in the frame back surface side space to be widely used, and the degree of freedom of dimensional design of the board is further improved.

A fourth aspect is an aspect according to the first aspect, wherein the board includes a connector connection section on a surface facing upward.

The board is provided such that the first side faces the first frame surface of the frame and the second side is farther from the frame than the first side in a direction intersecting the first frame surface. In this configuration, one board surface of two board surfaces in a front-back relationship faces upward with respect to the other board surface. That is, the board has an upwardly facing surface and a downwardly facing surface.

According to this aspect, since the board includes the connector connection section on the surface facing upward, the operation of inserting and removing the connector into and from the connector connection section is facilitated.

Note that the present aspect is not limited to the first aspect and may be dependent on the second or third aspect. When the fourth aspect is an aspect according to the second aspect, the board is provided such that the first side faces the first frame surface of the frame and the second side forms a gap in the horizontal direction between the board and the medium support section. Therefore, one board surface faces upward and the other board surface faces downward. In other words, the board has an upper surface and a lower surface. According to this aspect, since the board includes the connector connection section on the upper surface, the operation of inserting and removing the connector into and from the connector connection section is further facilitated.

A fifth aspect is an aspect according to the first aspect, the recording device further including a shield plate on an underside of the board, wherein the frame includes a frame fixing section that protrudes from the first frame surface toward the medium support section, the shield plate is fixed to the frame fixing section from above with screws, and the board is fixed to the shield plate from above with screws in a state of being placed on the shield plate.

According to this aspect, since the shield plate is fixed to the frame fixing section by screws from above, the shield plate is fixed by screws from above and the fixing work of the shield plate is facilitated. Similarly, since the board is fixed to the shield plate from above with screws in a state of being placed on the shield plate, the board is fixed with screws from above and the fixing work of the board is facilitated.

Note that the present aspect is not limited to the first aspect and may be according to any of the second to fourth aspects.

A sixth aspect is an aspect according to the fifth aspect, the recording device further including a passage detection section that detects passage of a medium downstream of the feed roller in a medium transport path, wherein the passage detection section includes a lever that swings in contact with the medium and a lever detection section that detects a change in posture of the lever, the lever is swingably supported by a holder member fixed to the first frame surface of the frame, the lever detection section is provided on a lower surface of the board, and the holder member supports the shield plate.

According to this aspect, since the holder member supports the shield plate, the shield plate, that is, the board, is more firmly supported.

A seventh aspect is an aspect according to the sixth aspect, wherein the shield plate is fixed to the holder member from above with screws.

According to this aspect, since the shield plate is fixed to the holder member by screws from above, the shield plate is fixed by screws from above and the fixing work of the shield plate is facilitated.

An eighth aspect is an aspect according to the sixth or seventh aspect, the recording device further including a medium detection section that detects presence or absence of a medium on the medium support section, wherein the medium detection section includes a swing section that swings in contact with the medium placed on the medium support section and a swing detection section that detects a change in the posture of the swing section, the swing section is swingably supported by the holder member, and the swing detection section is provided on a lower surface of the board.

Since the board is provided so as to extend from the first frame surface of the frame toward the medium support section, a configuration related to the medium support section is easily provided.

According to the present aspect, the swing detection section is provided on the lower surface of the board by using such a property. By this, a dedicated board for providing the swing detection section is not required, and thus it is possible to suppress an increase in cost of the device and to suppress an increase in size of the device.

A ninth aspect is an aspect according to the first aspect, wherein a distance between the first side and the second side of the board is longer than a length of the first frame surface in a vertical direction.

According to the present aspect, the distance between the first side and the second side of the board is longer than the vertical length of the first frame surface, and thus the dimension of the board can be secured.

Note that the present aspect is not limited to the first aspect and may be dependent on any of the second to sixth aspects.

A tenth aspect is an aspect according to the first aspect, the recording device further including an image reading section that reads an image of a document is provided on an upper portion of the frame.

In a configuration in which the image reading section that reads an image of a document is provided on the upper portion of the frame, the dimension of the device in the height direction is tends to increase. However, according to the present aspect, the dimension of the device in the height direction can be suppressed by the operation and effect of the first aspect.

Note that the present aspect is not limited to the first aspect and may be according to any one of the second to ninth aspects.

Hereinafter, the present disclosure will be described in detail.

Hereinafter, an inkjet printer 1 that performs recording by ejecting ink, which is an example of liquid, onto a medium such as recording sheet, will be described as an example of a recording device. Hereinafter, the inkjet printer 1 will be referred to simply as a printer 1.

An X-Y-Z coordinate system illustrated in each drawing is an orthogonal coordinate system, and a Y-axis direction is a transport direction of a medium during recording and also the depth direction of the device. In each of the X-axis, the Y-axis, and the Z-axis, a direction indicated by an arrow is defined as a +direction, and an opposite direction is defined as a −direction. In the present embodiment, among the side surfaces constituting the periphery of the printer 1, the side surface in the +Y direction is the front surface, and the side surface in the −Y direction is the back surface.

An X-axis direction is a device width direction and, as viewed from an operator of the printer 1, a +X direction is to a left side and a −X direction is to a right side. The X-axis direction is the medium width direction. Hereinafter, the X-axis direction may be simply referred to as a width direction.

A Z −axis direction is a vertical direction, that is, a device height direction, a +Z direction is an upward direction, and a −Z direction is a downward direction.

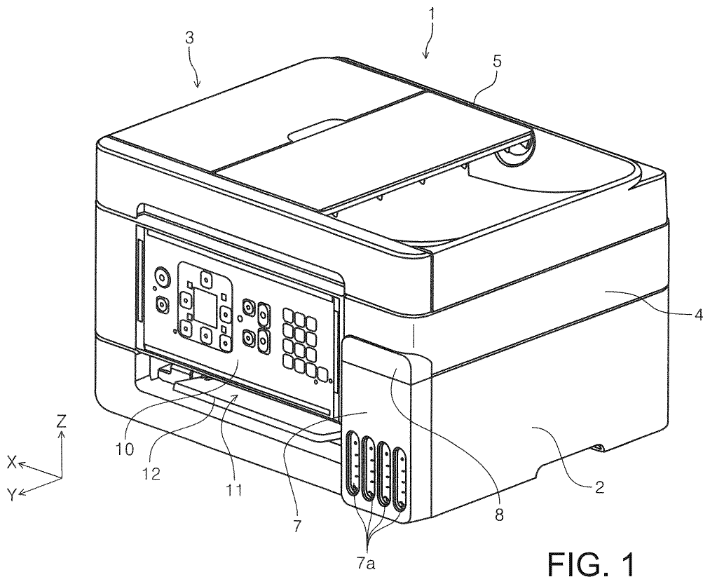

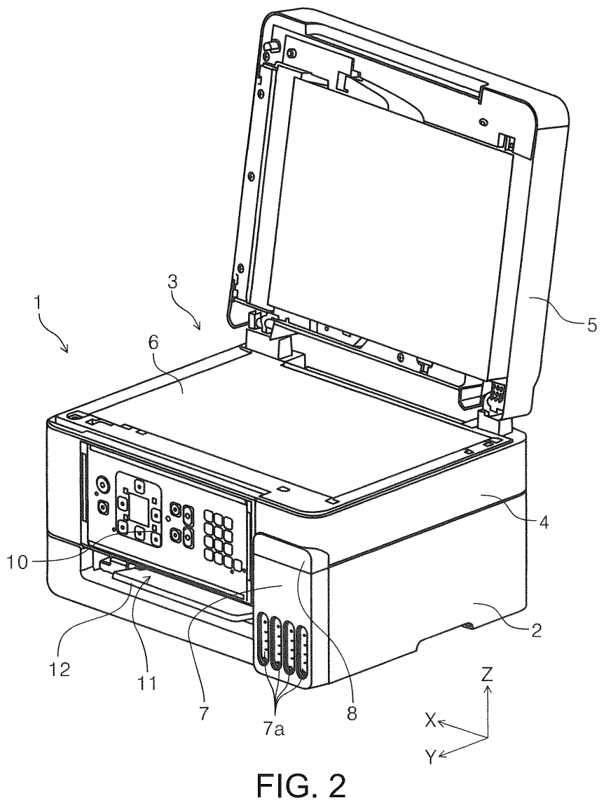

As illustrated in FIG. 1, the printer 1 is configured as a multifunction machine including a recording unit 2 and a scanner section 3 disposed on the recording unit 2. The scanner section 3 as an image reading section that reads an image of a document includes a reading section 4 and an automatic document feed section 5 provided above the reading section 4. The automatic document feed section 5 is provided to be rotatable with respect to the reading section 4, and when the automatic document feed section 5 is opened, a document table 6 constituting the reading section 4 is exposed as illustrated in FIG. 2. A reading sensor (not shown) is provided below the document table 6. The automatic document feed section 5 transports a document to a reading position of a reading sensor.

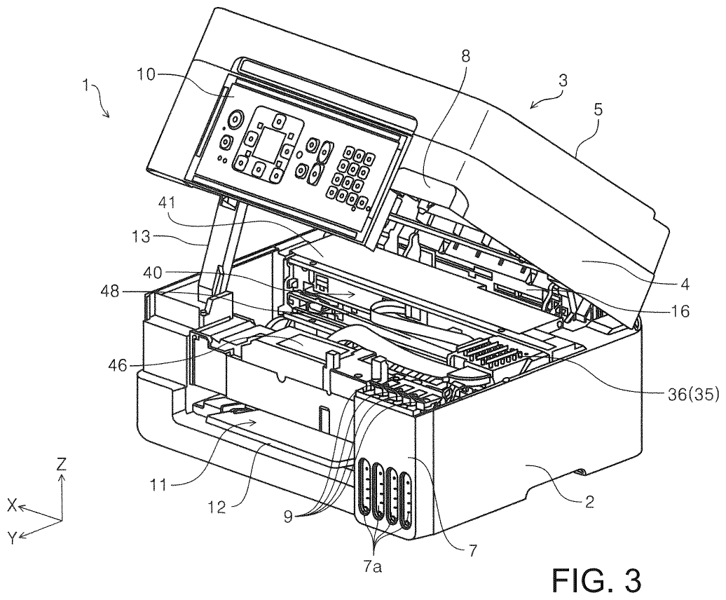

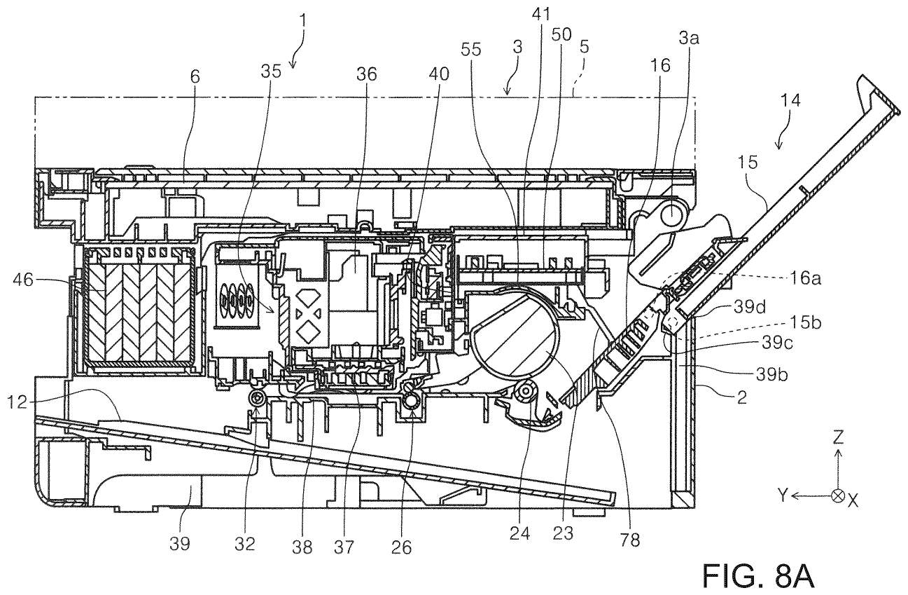

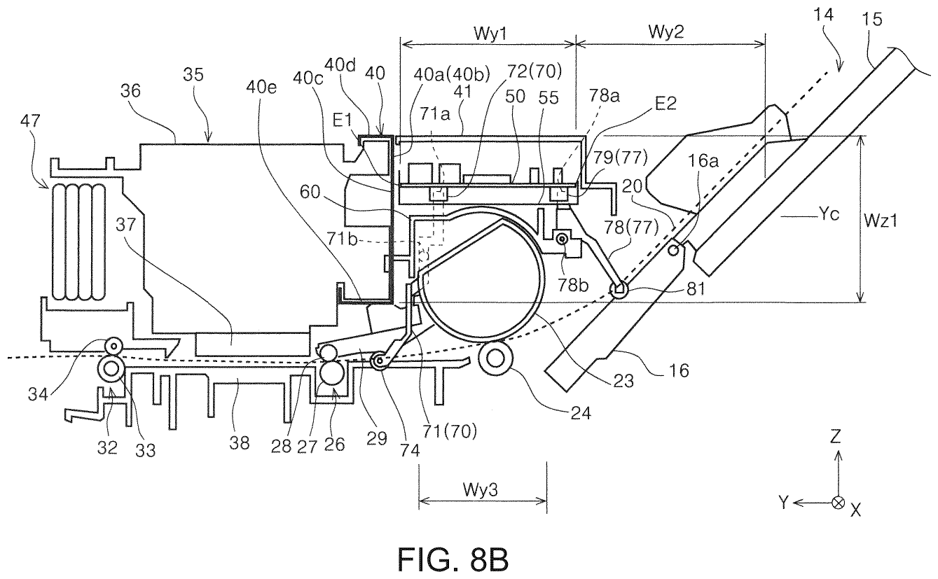

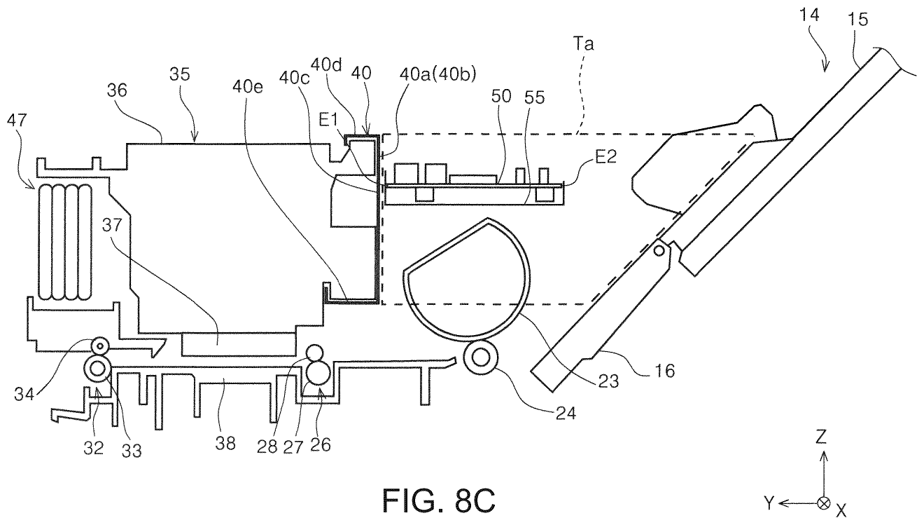

The scanner section 3 is rotatably connected to the recording unit 2 via a rotation shaft 3a (refer to FIG. 8A) and, by rotating, can take a closed state as illustrated in FIG. 1 and an open state as illustrated in FIG. 3. In FIG. 3, reference numeral 13 denotes a support arm, and the support arm 13 holds the scanner section 3 in an open state.

When the scanner section 3 is opened, the inside of the recording unit 2 is exposed.

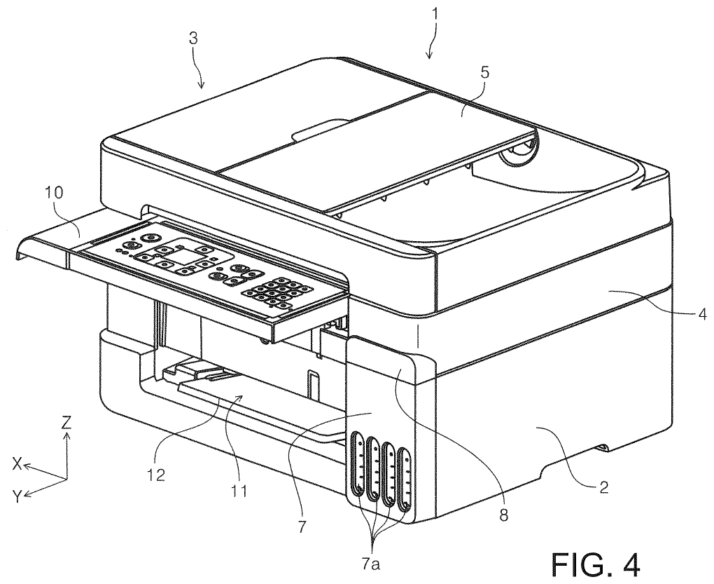

In FIG. 1, an operation panel 10 is provided on the front side of the recording unit 2. The operation panel 10 is tiltable, and can take a state in which a panel surface is along a vertical direction as illustrated in FIG. 1 and a state in which the panel surface faces upward as illustrated in FIG. 4.

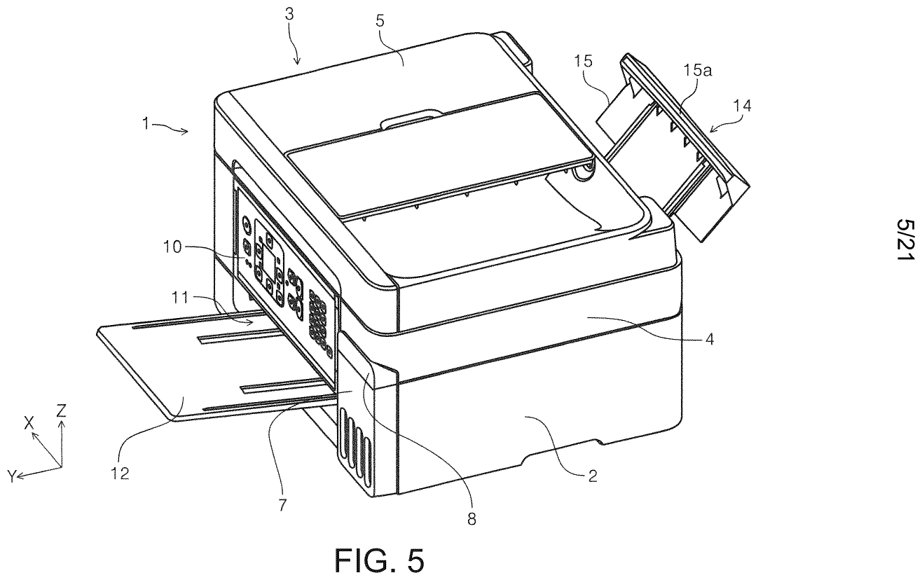

A discharge port 11 is formed on the front side of the recording unit 2. A medium receiving tray 12 is provided at the discharge port 11. The medium receiving tray 12 is configured to be switchable between a stored state illustrated in FIG. 1 and a pulled-out state illustrated in FIG. 5 with respect to the recording unit 2.

An ink storage section 7 is provided on the front side of the recording unit 2. The ink storage section 7 can store a plurality of colors of ink, for example, yellow, magenta, cyan, and black inks. A remaining ink amount viewing window 7a for viewing the remaining amount of ink is provided on the front surface side of the ink storage section 7.

A cover 8 is provided on the upper portion of the ink storage section 7. The cover 8 is provided integrally with the scanner section 3, and when the scanner section 3 is opened, the upper portion of the ink storage section 7 is exposed as illustrated in FIG. 3.

In FIG. 3, reference numeral 9 denotes a cap lever. The cap lever 9 is openable and closable, and an ink inlet (not shown) can be exposed by opening the cap lever 9. Ink can be replenished from the ink inlet.

As illustrated in FIGS. 5, 6, and 8A, a medium support section 14 that supports medium in an inclined posture before feeding is provided on the rear surface side of the recording unit 2.

The medium support section 14 includes a support section 15 and a swing support section 16. The swing support section 16 is swingable about a swing shaft 16a (see FIG. 8A), and swings by receiving power of a motor (not shown), thereby bringing the supported medium into contact with the feed roller 23.

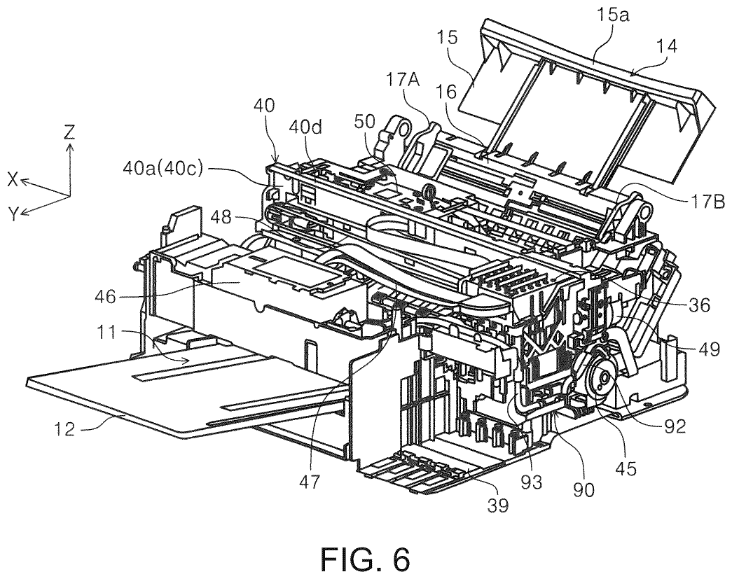

As illustrated in FIG. 6, the swing support section 16 is provided with edge guides 17A and 17B for guiding the edges of the medium in the widthwise direction. The edge guides 17A and 17B are provided so as to approach or separate from each other along the widthwise direction of the medium by a rack and pinion mechanism (not shown).

The support section 15 can take an expanded state illustrated in FIGS. 5, 6, and 8A and a stored state (not illustrated). The support section 15 takes an inclined posture in the expanded state illustrated in FIGS. 5, 6, and 8A. The support section 15 is in a vertical posture in a stored state (not shown) and is stored on the back side of the base frame 39. As illustrated in FIG. 8A, a guide section 39b extending in the vertical direction is formed on the back side of a base frame 39 that constitutes the base of the recording unit 2. A swing shaft 15b is formed in the support section 15, and the swing shaft 15b is provided to be movable along the vertical direction in the guide section 39b.

In the stored state of the support section 15, the swing shaft 15b is located at the lower end portion of the guide section 39b. When the user pulls up the support section 15 from this state to set the support section 15 in the inclined posture, the swing shaft 15b enters the holding section 39c provided on the upper portion of the guide section 39b. The back surface side of the support section 15 contacts against the contact section 39d of the base frame 39, and the inclined posture is maintained.

As illustrated in FIG. 6, a curved support section 15a is formed on the upper portion of the support section 15. The medium supported by the support section 15 is formed by the curved support section 15a into a downward projecting curve along the widthwise direction, and thus the upper end portion of the medium is suppressed from hanging down backward.

Hereinafter, a medium transport path 20 in the recording unit 2 will be described with reference to FIG. 8B. Note that FIG. 8B is an outline of configuration illustrated in FIG. 8A that was extracted as appropriate.

Hereinafter, a direction in which the medium is transported may be referred to as “downstream”, and an opposite direction of it may be referred to as “upstream”. In FIG. 8B, the medium transport path 20 is indicated by a dashed line. In the printer 1, the medium is transported through the transport path 20.

The above-described medium support section 14 is provided on the most upstream side of the transport path 20.

The medium supported by the medium support section 14 is nipped and separated by a feed roller 23 driven by a motor (not shown) and a separation roller 24 to which a rotational resistance is applied, and is sent toward a transport roller pair 26.

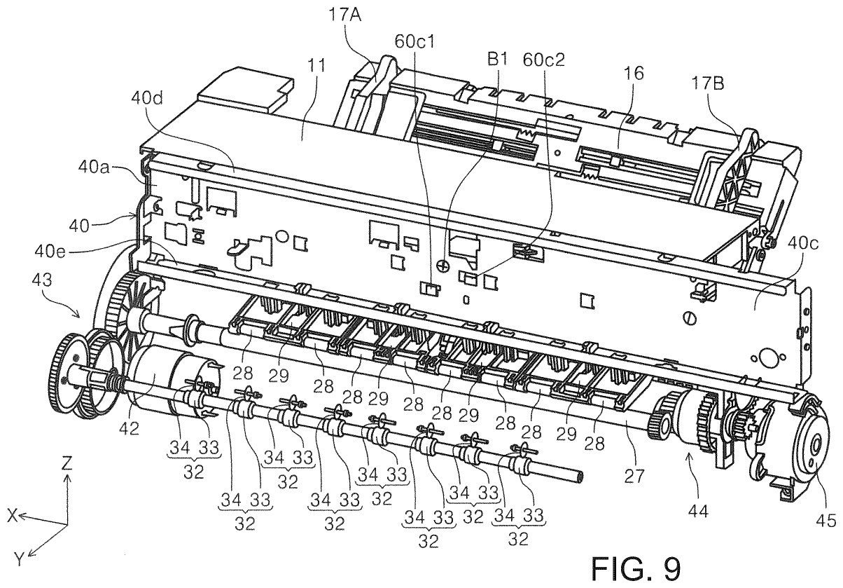

The transport roller pair 26 includes a transport drive roller 27 that is driven by a transport motor 42 (refer to FIG. 9), and a transport driven roller 28 that nips the medium between the transport drive roller 27 and the transport driven roller 28. The transport driven roller 28 is rotatably supported by a roller support member 29.

In the present embodiment, the transport drive roller 27 is a shaft body extending in the width direction as illustrated in FIG. 9. In the embodiment, as illustrated in FIG. 9, a plurality of the transport driven rollers 28 are provided at appropriate intervals along the width direction with respect to the transport drive roller 27.

In the present embodiment, two transport driven rollers 28 are supported by one roller support member 29.

The roller support member 29 is swingably attached to the main frame 40 via a swing shaft (not shown), and the transport driven roller 28 advances and retreats with respect to the transport drive roller 27 by swinging. The roller support member 29 is pressed in a direction in which the transport driven roller 28 advances with respect to the transport drive roller 27 by a pressing member (not shown), for example, a torsion spring or a tension spring.

Returning to FIG. 8B, the recording section 35 includes a carriage 36 and a recording head 37. The carriage 36 is supported by the main frame 40 and guided in the width direction. The carriage 36 reciprocates in the width direction by receiving power of a carriage motor 49 (refer to FIG. 6).

A recording head 37 is provided below the carriage 36. The recording head 37 is provided with a plurality of ink ejection nozzles (not shown) capable of ejecting ink in the −Z direction. The ink storage section 7 and the carriage 36 described above are connected by an ink tube 47, and ink is supplied from the ink storage section 7 through the ink tube 47.

Note that in the printer 1 according to the embodiment, the ink storage section 7 is independent of the carriage 36, but the ink storage section 7 may be provided in the carriage 36. The recording section 35 according to the present embodiment has a configuration in which the recording head 37 ejects ink while moving in the width direction, that is, a serial type. The recording section 35 is not limited to a serial type, and may have a configuration in which ink ejection nozzles are disposed so as to cover the entire region in the width direction and recording can be performed without movement in the width direction, that is, a line head.

Further, the recording method is not limited to the ink jet method, and may be a dot impact method, a laser method, or an LED type electrophotographic method.

Next, a support member 38 that supports the medium is provided at a position that can face the recording head 37. The support member 38 defines a distance between the medium and the recording head 37. The recording head 37 ejects ink onto the medium supported by the support member 38, and performs recording on the recording surface of the medium. The medium on which recording has been performed is nipped by the discharge roller pair 32 provided downstream of the recording head 37 in the transport path 20, and is discharged toward the medium receiving tray 12.

The discharge roller pair 32 includes a discharge drive roller 33 driven by a transport motor 42 (refer to FIG. 9) and a discharge driven roller 34 that nips the medium between the discharge drive roller 33 and the discharge driven roller 34.

In the present embodiment, a plurality of discharge roller pairs 32 are provided at appropriate intervals along the width direction as illustrated in FIG. 9. In the present embodiment, the discharge driven roller 34 is a toothed roller having teeth on the outer periphery thereof. The discharge driven roller 34 is capable of advancing and retreating with respect to the discharge driving roller 33, and nips the medium between the discharge drive roller 33 and the discharge driven roller 34 by using the rod spring as a rotation shaft.

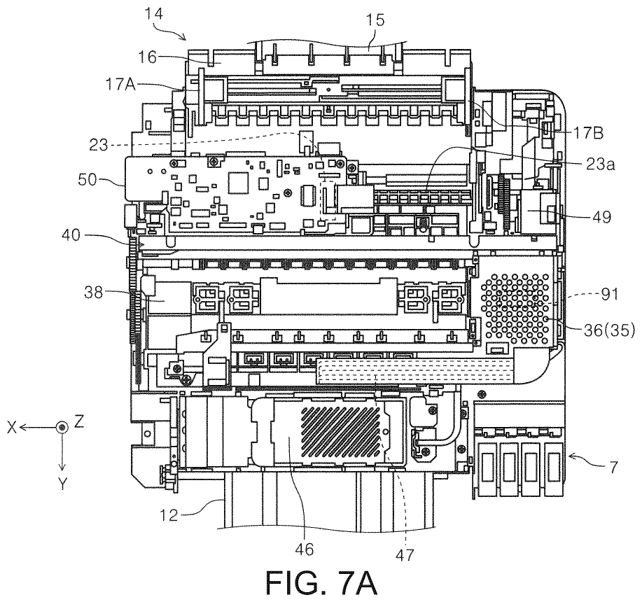

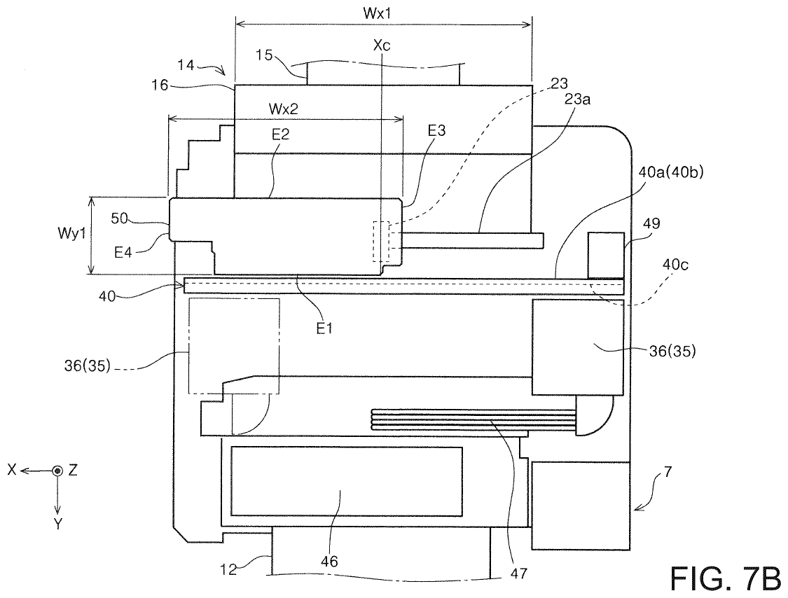

Note that as illustrated in FIG. 6, a maintenance unit 90 is provided at an end portion in the −X direction in the reciprocating region of the carriage 36. The maintenance unit 90 is provided with a cap 91 (see FIG. 7A) capable of sealing the ink ejection surface of the recording head 37. A suction pump 45 is provided at a position adjacent to the maintenance unit 90, and the suction pump 45 and the cap 91 are connected by a tube 92. By this, when the suction pump 45 is operated, a negative pressure is supplied into the cap 91, and the waste ink is sucked from the cap 91.

The waste ink sucked by the suction pump 45 is sent to the waste liquid storage section 46 through the tube 93 and collected. The waste liquid storage section 46 is provided in an upper portion on the front side of the device.

The suction pump 45 is driven by the transport motor 42 shown in FIG. 9. If the rotation direction of the transport motor 42 when transporting the medium downstream is defined as a forward rotation direction, the suction pump 45 operates only when the transport motor 42 rotates in a reverse rotation direction.

The power of the transport motor 42 is transmitted to the +X direction end portion of the transport drive roller 27 by a first power transmission section 43 configured to include a plurality of gears. A second power transmission section 44 configured to include a plurality of gears is provided at the end portion of the transport drive roller 27 in the −X direction, and power of the transport motor 42 is transmitted to the suction pump 45 via the second power transmission section 44. Note that a one way clutch (not shown) is provided inside the suction pump 45 so that the power of the transport motor 42 is transmitted to the suction pump 45 only when the transport motor 42 rotates in the reverse direction.

Next, the medium detection section 77 and the passage detection section 70 will be described.

In FIG. 8B, the printer 1 includes a medium detection section 77 for detecting the presence or absence of medium on the medium support section 14.

The medium detection section 77 includes a swing section 78 that swings in contact with the medium placed on the medium support section 14, and a swing detection section 79 that detects a change in the posture of the swing section 78. The swing section 78 is swingably supported by the holder member 60, which will be described later, via a swing shaft 78b.

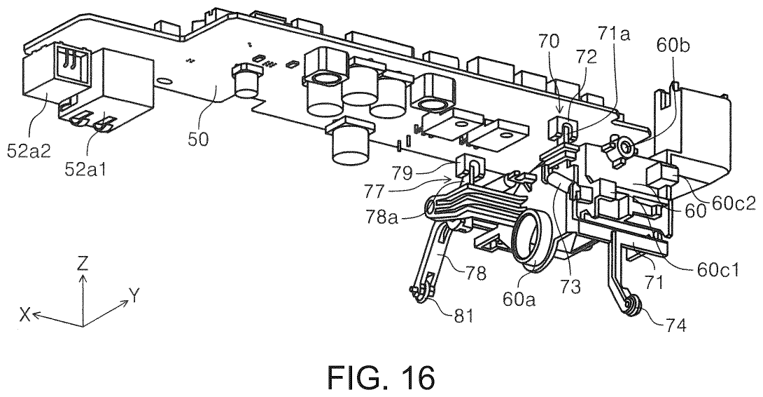

The upper part of the swing section 78 is configured as a detected section 78a, and when there is no medium on the medium support section 14, the detected section 78a enters the swing detection section 79 as illustrated in FIG. 8B (also refer to FIG. 16). When the medium is set on the medium support section 14 from this state, the lower end portion of the swing section 78 moves downstream, the swing section 78 swings, and the detected section 78a is separated from the swing detection section 79. A control section (not shown) of the printer 1 can detect the presence or absence of the medium on the medium support section 14 based on the signal change of the swing detection section 79.

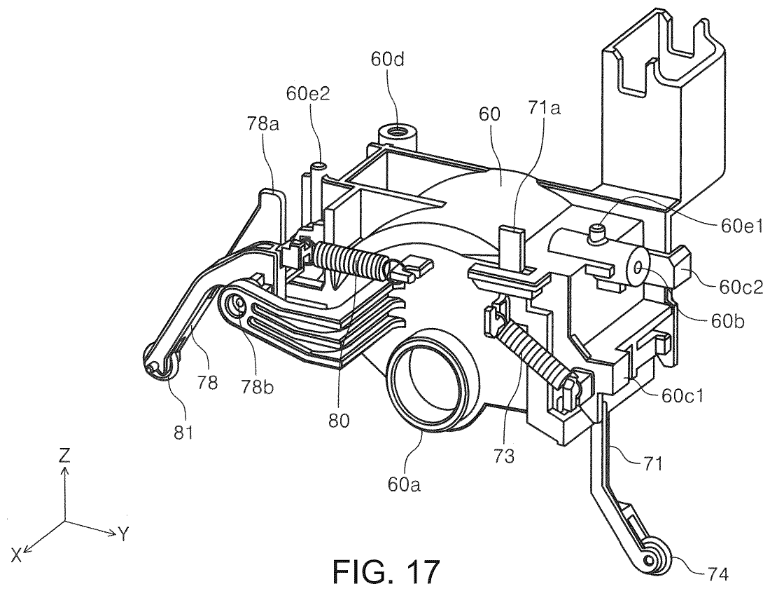

Note that a roller 81 is provided at a lower end portion of the swing section 78, and thus, frictional resistance when the medium comes into contact with the swing section 78 is reduced. The swing section 78 is pressed by a spring 80 illustrated in FIG. 17 in a direction to take the posture of FIG. 8B, that is, a posture of blocking the transport path 20.

The swing detection section 79 is provided on the lower side of the main board 50 described later.

Next, as illustrated in FIG. 8B, the printer 1 includes a passage detection section 70 for detecting the passage of medium downstream of the feed roller 23.

The passage detection section 70 includes a lever 71 that swings in contact with the medium and a lever detection section 72 that detects a change in the posture of the lever 71. The lever 71 is swingably supported by the holder member 60, which will be described later, via a swing shaft 71b.

The upper portion of the lever 71 is configured as a detected section 71a, and when the medium is not being transported, the detected section 71a enters the lever detection section 72 as illustrated in FIG. 8B (see also FIG. 16). When the medium pass through from this state, the lower end portion of the lever 71 moves downstream, the lever 71 swings, and the detected section 71a is separated from the lever detection section 72. A control section (not shown) of the printer 1 can detect the passage of the medium based on the signal change of the lever detection section 72.

Note that a roller 74 is provided at the lower end of the lever 71 and thereby reduces the frictional resistance when the medium comes into contact with the lever 71. The lever 71 is pressed by a spring 73 illustrated in FIG. 17 in a direction to take the posture in FIG. 8B, that is, a posture of blocking the transport path 20.

The lever detection section 72 is provided on the lower side of the main board 50 described later.

Next, the main frame 40 will be described. The main frame 40 is a frame that constitutes a base body of the recording unit 2. Referring to FIGS. 8B and 9, the main frame 40 is formed by bending a metallic plate material so as to have a vertical frame section 40a, an upper bent section 40d, and a lower bent section 40e. The end portion of the upper bent section 40d in the +Y direction is further bent in the −Z direction. The end of the lower bent section 40e in the +Y direction is further bent in the +Z direction.

The vertical frame section 40a is a portion forming a surface parallel to the X-Z plane, and has a first frame surface 40b, which is a surface on the back surface side, and a second frame surface 40c which is a surface on the front surface side and is a surface opposite to the first frame surface 40b.

The upper bent section 40d and the lower bent section 40e are portions forming surfaces parallel to the X-Y plane.

The main frame 40 is located between the medium support section 14 and the recording section 35, the first frame surface 40b faces the feed roller 23, and the second frame surface 40c faces the recording section 35.

A carriage motor 49 (refer to FIG. 6) is provided on the first frame surface 40b of the vertical frame section 40a. An endless belt 48 (see FIG. 6) for pulling the carriage 36 is provided on the second frame surface 40c of the vertical frame section 40a.

A roller support member 29 is swingably supported on the lower bent section 40e. The lower bent section 40e supports the carriage 36 and guides the carriage 36 in the widthwise direction.

Next, the main board 50 provided on the back side of the main frame 40 will be described. The main board 50 constitutes a control section that controls the entire printer 1, and various electronic components and connectors are mounted thereon. A driver circuit for driving the transport motor 42 (refer to FIG. 9) or the carriage motor 49 (refer to FIG. 6) is mounted on the main board 50. A communication section for communicating with an external terminal is mounted on the main board 50.

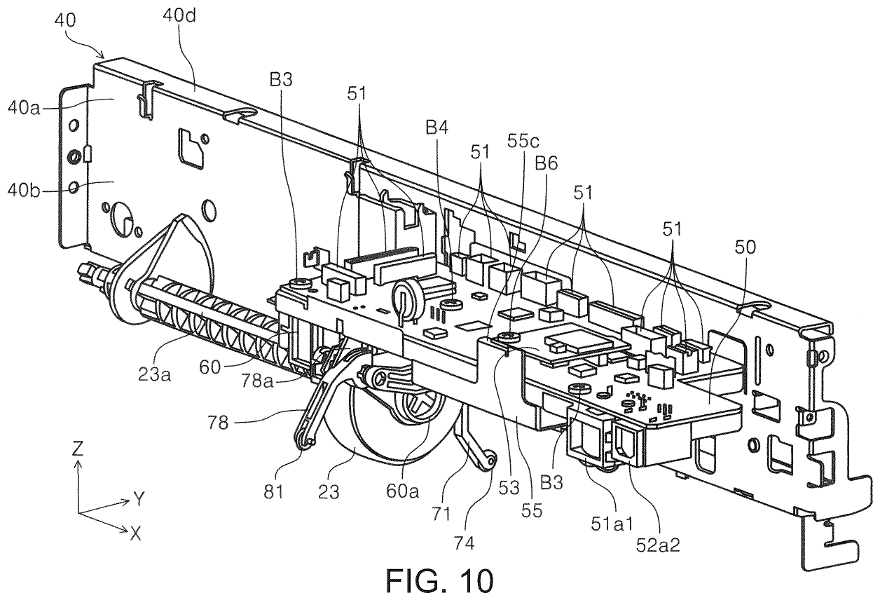

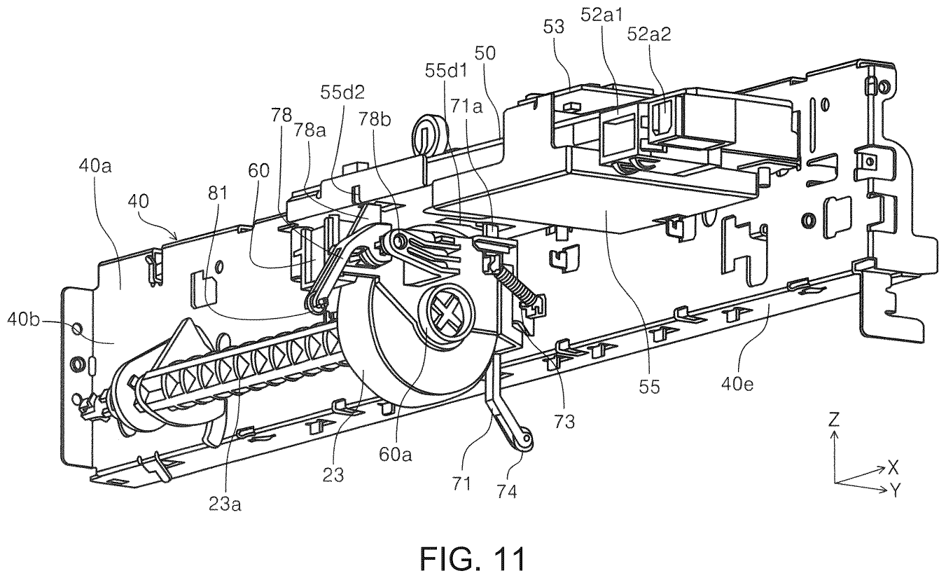

The main board 50 is provided on the back side of the main frame 40 and below the cover member 41 (see FIG. 9). FIGS. 10 and 11 show a state in which the cover member 41 is removed and the main board 50 is exposed.

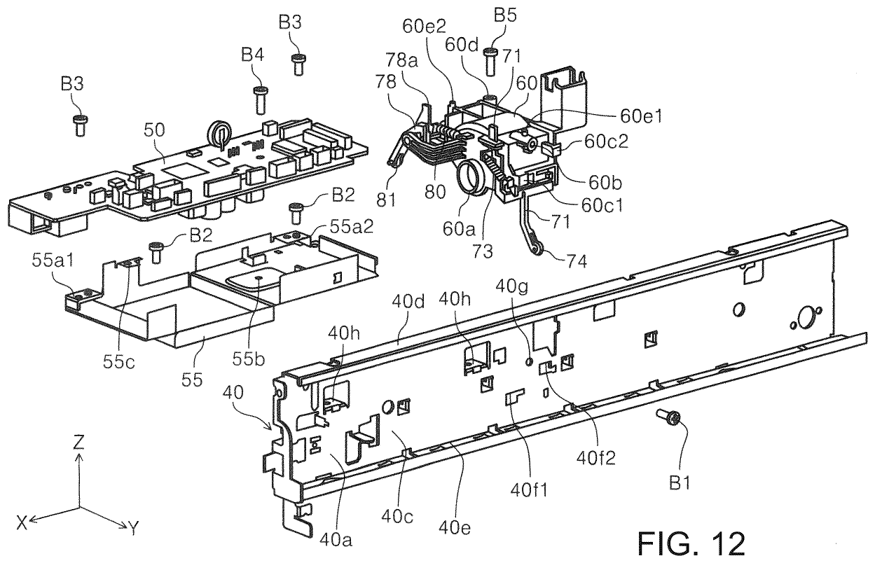

FIG. 12 is an exploded perspective view of members related to the attachment of the main board 50. Hereinafter, the attachment of the main board 50 to the main frame 40 will be described.

As illustrated in FIG. 12, the vertical frame section 40a is formed with locking holes 40f1 and 40f2 and a screw insertion hole 40g, and the holder member 60 is provided on the first frame surface 40b by using these.

As illustrated in FIGS. 10 and 11, the holder member 60 includes a bearing section 60a that supports the shaft end of the feed roller shaft 23a, which is the shaft of the feed roller 23. The holder member 60 is provided with the swing section 78 and the lever 71 as described above.

As illustrated in FIG. 12, the holder member 60 is formed with locking sections 60c1 and 60c2 and a screw hole 60b. The locking section 60c1 can enter the locking hole 40f1 of the vertical frame section 40a, and the locking section 60c2 can enter the locking hole 40f2 of the vertical frame section 40a. By this, the holder member 60 is supported by the vertical frame section 40a. The screw B1 passes through the screw insertion hole 40g of the vertical frame section 40a and fits into the screw hole 60b, whereby the holder member 60 is fixed to the vertical frame section 40a.

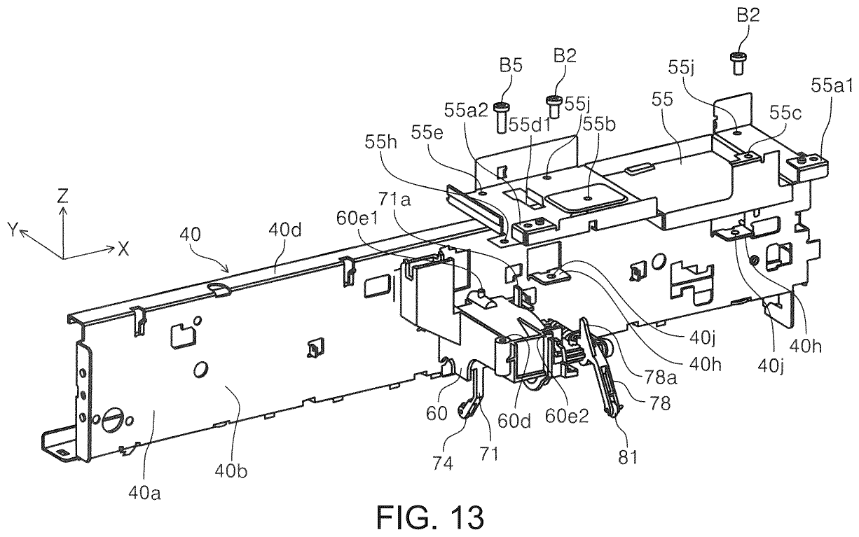

When the main board 50 is attached to the main frame 40, the holder member 60 is first attached to the main frame 40 in this manner. FIG. 13 shows a state in which the holder member 60 is attached to the main frame 40.

Next, two frame fixing sections 40h are formed on the vertical frame section 40a so as to protrude towards the back surface side, and screw holes 40j are formed in the frame fixing section 40h. The holder member 60 is formed with a screw hole 60d.

The shield plate 55 is fixed to the frame fixing section 40h and the holder member 60. The shield plate 55 is formed of a metal plate material and performs a shield function for the main board 50.

Here, the holder member 60 is formed with bosses 60e1 and 60e2 for defining the position with the shield plate 55. The shield plate 55 is formed with a fitting hole 55e into which the boss 60e1 fits, and also with a fitting hole (not shown) into which the boss 60e2 fits.

Therefore, if the shield plate 55 is first fixed to the frame fixing section 40h, the positional relationship between the boss 60e1 and the fitting hole 55e and the positional relationship between the boss 60e2 and the fitting hole (not shown) will be misaligned. As a result, there is a risk that the boss and the fitting hole will not be able to fit together. If the boss and the fitting hole are forcibly fitted to each other, the shield plate 55 may be deformed.

Therefore, first, the boss and the fitting hole are fitted to each other, and the shield plate 55 is fixed to the holder member 60 by a screw B5 in a state where the positional relationship between the holder member 60 and the shield plate 55 is determined. The screw B5 passes through the screw insertion hole 55h of the shield plate 55 and is fitted into the screw hole 60d of the holder member 60.

Then, the shield plate 55 is fixed to the frame fixing section 40h by a screw B2. The screw B2 passes through the screw insertion hole 55j of the shield plate 55 and is fitted into the screw hole 40j of the frame fixing section 40h.

As described above, the shield plate 55 is appropriately fixed.

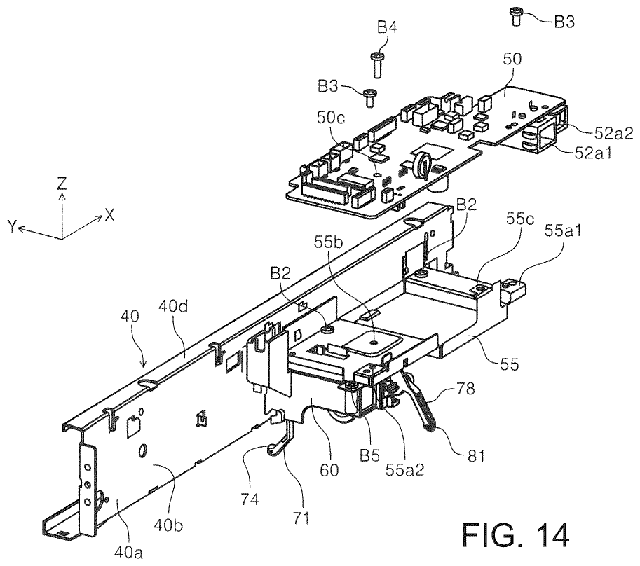

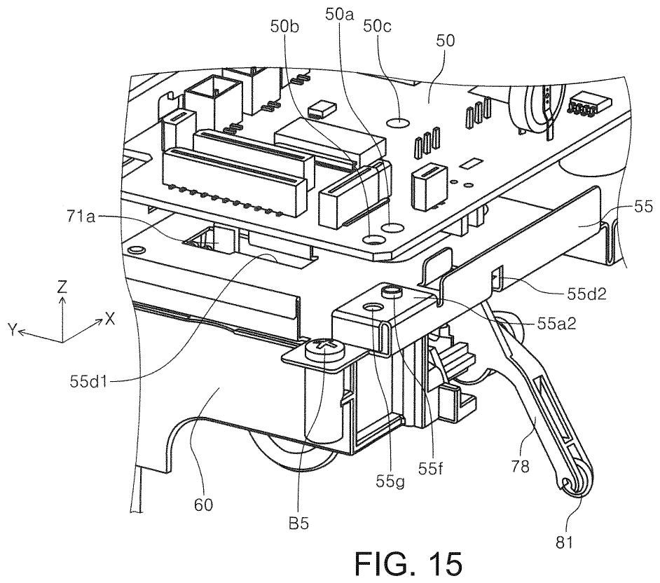

Next, the shield plate 55 is formed with board fixing sections 55a1 and 55a2. The board fixing sections 55a1 and 55a2 are formed with screw holes and bosses, and FIG. 15 shows a screw hole 55g and a boss 55f formed in the board fixing section 55a2. A screw insertion hole 50b and a boss fitting hole 50a are formed in the main board 50, and the main board 50 is positioned with respect to the shield plate 55 by fitting the boss 55f into the boss fitting hole 50a. A screw B3 (see FIG. 14) passes through the screw insertion hole 50b and is fitted to the screw hole 55g.

A screw hole 55b is formed in the shield plate 55, and a screw B4 passes through the screw insertion hole 50c of the main board 50 and is fitted into the screw hole 55b.

Note that a screw hole (not shown) corresponding to the above-mentioned screw hole 55g is also formed in the board fixing section 55a1, and a boss (not shown) corresponding to the above-mentioned boss 55f is also formed. The main board 50 has a screw insertion hole (not shown) corresponding to the above-described screw insertion hole 50b is formed at a position corresponding to the board fixing section 55a1. The main board 50 also has a boss fitting hole (not shown) corresponding to the above-described boss fitting hole 50a at a position corresponding to the board fixing section 55a1. Note that this boss fitting hole (not shown) is formed in an elongated shape that is slightly longer in the X-axis direction, unlike the boss fitting hole 50a described above.

In this way, the main board 50 is positioned and fixed to the shield plate 55.

Note that as illustrated in FIG. 15, a slit 55d1 is formed in the shield plate 55, and the upper end portion of the lever 71 protrudes upward from the lower side of the shield plate 55 through the slit 55d1. A slit 55d2 is formed in the shield plate 55, and the upper end portion of the swing section 78 protrudes upward from the lower side of the shield plate 55 through the slit 55d2. By this, as illustrated in FIG. 16, the detected section 78a of the swing section 78 can enter the swing detection section 79, and the detected section 71a of the lever 71 can enter the lever detection section 72.

As described above, the relative position between the main board 50 and the holder member 60 is important, and the relative position between the shield plate 55 and the holder member 60 is also important. Therefore, it is preferable to fix the shield plate 55 to the holder member 60 before fixing the shield plate 55 to the main frame 40. However, when the relative position between the holder member 60 and the main board 50 can be ensured by the component accuracy, the shield plate 55 may be fixed to the main frame 40 before the shield plate 55 is fixed to the holder member 60.

Note that as illustrated in FIG. 14, a board fixing section 55c is formed on the shield plate 55, and the communication board 53 is fixed to the board fixing section 55c by a screw B6 as illustrated in FIG. 10.

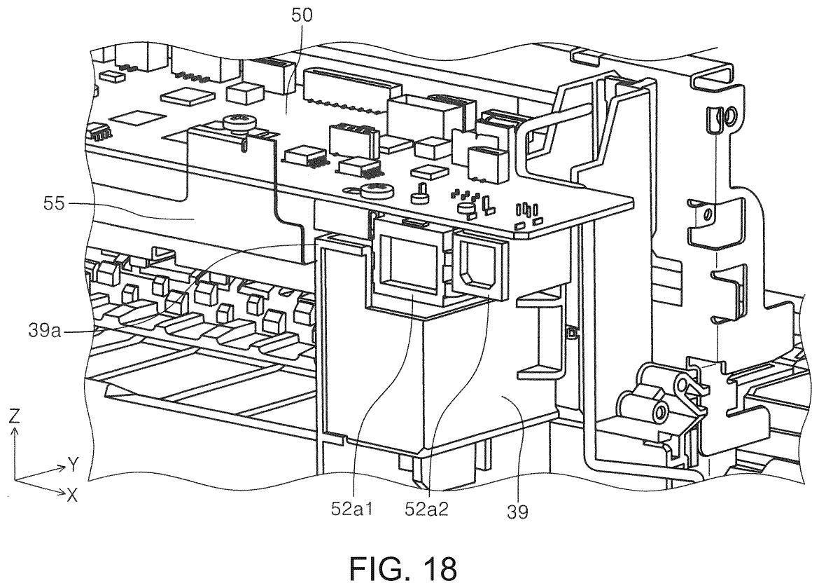

Note that the shield plate 55 is supported by the main frame 40 at two positions along the width direction at the end portion in the +Y direction, and the shield plate 55 is supported by the holder member 60 at the end portion in the −X direction at the end portion in the −Y direction, but is not supported by the holder member 60 at the end portion in the +X direction at the end portion in the −Y direction. Therefore, as illustrated in FIG. 18, the end portion of the shield plate 55 in the +X direction is supported by the base frame 39 at the end portion of the shield plate 55 in the −Y direction. The reference numeral 39a denotes a portion where the base frame 39 supports the shield plate 55.

Note that reference numerals 52a1 and 52a2 denote connector connection sections to which connectors provided at one end of communication cables (not shown) are connected.

Next, the operations and effects of the printer 1 configured as above will be described.

First, as illustrated in FIG. 7B, the side of the main board 50 in the +Y direction is referred to as a first side E1, the side in the −Y direction is referred to as a second side E2, the side in the −X direction is referred to as a third side E3, and the side in the +X direction is referred to as a fourth side E4. Note that FIG. 7B is an outline of configuration illustrated in FIG. 7A that was extracted as appropriate. The carriage 36 indicated by a two dot chain line in FIG. 7B indicates the carriage 36 that has moved to the most in the +X direction.

The first side E1 is a side of the main board 50 in the most +Y direction. The second side E2 is a side of the main board 50 in the most −Y direction. The third side E3 is a side of the main board 50 in the most −X direction. The fourth side E4 is a side of the main board 50 in the most +X direction. In the present embodiment, the first side E1 and the second side E2 are parallel to each other and extend along the X-axis direction. The third side E3 and the fourth side E4 are parallel to each other and extend along the Y-axis direction.

Note that first side E1 and the second side E2 may not necessarily be parallel to each other. The third side E3 and the fourth side E4 are not necessarily parallel to each other. That is, the main board 50 does not need to be rectangular as a whole.

The main board 50 is provided so that the first side E1 faces the first frame surface 40b of the main frame 40 and the second side E2 is located in a direction intersecting the first frame surface 40b and is farther away from the main frame 40 than the first side E1. Note that in FIG. 8B, the reference numeral Wy1 denotes the length between the first side E1 and the second side E2, in other words, the size of the main board 50 in the Y-axis direction. As is clear from FIG. 8B, the second side E2 is farther from the main frame 40 than the first side E1 in the −Y direction intersecting the first frame surface 40b.

Note that in FIG. 8B, the reference numeral Wy2 denotes the gap formed between the second side E2 and the medium support section 14 in the Y-axis direction. By providing the gap Wy2, it is possible to load the medium on the medium support section 14.

The following operations and effects are obtained by the above configuration.

In a configuration in which the medium support section 14 supports, in an inclined posture, the medium before feeding and the main frame 40 is provided between the medium support section 14 and the recording section 35, a space that expands upward is formed between the first frame surface 40b of the main frame 40 and the medium support section 14. FIG. 8C is a diagram illustrating this space, which is indicated by a dashed line denoted Ta. Hereinafter, this space is referred to as a space on the back side of the frame Ta.

According to the present embodiment, the main board 50 is provided such that the first side E1 faces the first frame surface 40b of the main frame 40 and the second side E2 is farther from the main frame 40 than the first side E1. This configuration allows the main board 50 to be disposed by effectively using the space on the back side of the frame Ta. This makes it possible to suppress an increase in size of the device that would otherwise be caused by the placement of the main board 50.

For example, even if the main board 50 is increased in size in the direction in which the distance Wy1 between the first side E1 and the second side E2 is increased, this does not lead to an increase in the height dimension of the device. Even if the main board 50 is increased in size in the direction in which the distance between the third side E3 and the fourth side E4 of the main board 50 increases, this does not lead to an increase in the height dimension of the device.

The first side E1 of the main board 50 faces the first frame surface 40b of the frame and the second side E2 is arranged so as to be farther away from the main frame 40 than the first side E1. With this configuration, even if the main board 50 becomes larger in the direction in which the distance between the third side E3 and the fourth side E4 increases, the main board 50 is unlikely to interfere with other components arranged on the first frame surface 40b.

In particular, in this embodiment, tension coil springs (not shown) that press the roller support members 29 (see FIG. 8B) are arranged side by side at intervals along the X-axis direction on the first frame surface 40b. For this reason, if the main board 50 were to be disposed in a vertical position, the tension coil would interfere with the main board 50, which would impose limitations on the arrangement and dimensions of the main board 50. If a torsion spring or the like that is smaller than the tension coil spring is used to suppress such a problem, the load tends to become unstable. However, according to the present embodiment, the main board 50 is less likely to interfere with the components provided on the first frame surface 40b, and thus the arrangement of the tension coil springs is less likely to be affected.

As described above, according to this embodiment, even if the main board 50 is enlarged, it is possible to achieve a configuration that is unlikely to lead to an increase in the height dimension of the device.

Note that the state in which the first side E1 faces the first frame surface 40b of the main frame 40 and the second side E2 is arranged in a direction intersecting the first frame surface 40b and away from the main frame 40 than the first side E1 is not limited to a state in which the main board 50 is aligned along a horizontal plane. The main board 50 may be in a state of intersecting the vertical plane.

In the present embodiment, the main board 50 is disposed in a posture along the horizontal plane, and thus the space on the back side of the frame Ta can be more efficiently used.

However, the main board 50 is not limited to this, and may be provided so as to form an inclined angle with respect to the horizontal plane.

The board disposed in the space on the back side of the frame Ta as described above is not limited to the main board 50, and may be another board, for example, a power supply board or the like.

In this embodiment, the main board 50 is disposed above the feed roller 23 and at a position overlapping with the feed roller 23 in a plan view as illustrated in FIG. 7B.

By this, it is possible to widely use the region above the feed roller 23 in the space on the back side of the frame Ta, further improving the degree of freedom in designing the dimensions of the main board 50.

Note that in FIG. 7B, reference numeral Xc denotes a center position in the width direction of the medium support section 14, and the feed roller 23 is disposed at the center position Xc. The main board 50 is disposed so as to include the center position Xc and be located more in the +X direction. However, the main board 50 may not include the center position Xc, and may not overlap with the feed roller 23 in plan view. The main board 50 may be disposed so as to be located more in the −X direction.

Note that in FIG. 8B, the reference numeral Wx2 denotes the distance between the third side E3 and the fourth side E4, in other words, the dimension of the main board 50 in the X-axis direction. In FIG. 8B, the reference numeral Wx1 denotes the dimension of the medium support section 14 in the X-axis direction

In FIG. 8B, the reference numeral Wz1 denotes the range of the main frame 40 in the Z-axis direction, and the reference numeral Yc denotes the center position of the main frame 40 in the Z-axis direction. The main board 50 is accommodated in the range Wz1, including the electronic components that are mounted on the surface facing upward, that is, the upper surface, and mounted on the surface facing downward, that is, the lower surface. The main board 50 including the electronic components mounted on the upper surface and the lower surface is located above the center position Yc. This allows the main board 50 to be further increased in size.

In FIG. 8B, a reference numeral Wy3 denotes the range of the feed roller 23 in the Y-axis direction. In the present embodiment, the feed roller 23 is accommodated between the first side E1 and the second side E2 of the main board 50 in the Y-axis direction.

In the present embodiment, the main board 50 includes a connector connection section 51 on the upper surface as illustrated in FIG. 10.

The main board 50 is provided so that the first side E1 faces the first frame surface 40b of the main frame 40, and the second side E2 forms a gap in the horizontal direction with the medium support section 14, so one board surface faces upward, and the other board surface faces downward. That is, the main board 50 has an upper surface and a lower surface.

According to the present embodiment, since the main board 50 includes the connector connection section 51 on the upper surface, the work of inserting and removing the connector into from the connector connection section 51 is facilitated.

In the embodiment, the printer 1 includes a shield plate 55 on the lower side of the main board 50. The main frame 40 has a frame fixing section 40h that protrudes from the first frame surface 40b toward the medium support section 14. The shield plate 55 is fixed to the frame fixing section 40h from above with screws. Then, the main board 50 is placed on the shield plate 55 and fixed to the shield plate 55 from above with screws.

In this way, since the shield plate 55 is fixed to the frame fixing section 40h by screws from above, and therefore, the shield plate 55 is fixed by screws from above, and the fixing work of the shield plate 55 is facilitated. Similarly, since the main board 50 is fixed to the shield plate 55 from above with screws in a state of being placed on the shield plate 55, and thus the main board 50 is fixed with screws from above, and the fixing work of the main board 50 is facilitated.

In the present embodiment, the lever 71 that constitutes the passage detection section 70 is swingably supported by the holder member 60, the lever detection section 72 is provided on the lower surface of the main board 50, and the holder member 60 supports the shield plate 55.

This allows the shield plate 55, that is, the main board 50, to be supported more firmly.

In the present embodiment, the shield plate 55 is fixed to the holder member 60 from above with screws. That is, since the shield plate 55 is fixed by screws from above, the fixing work of the shield plate 55 is facilitated.

In the embodiment, the swing section 78, which configures the medium detection section 77, is swingably supported by the holder member 60, and the swing detection section 79 is provided on the lower surface of the main board 50. The main board 50 is provided so as to extend from the first frame surface 40b of the main frame 40 toward the medium support section 14, and therefore, the configuration related to the medium support section 14 is easily provided.

According to the present embodiment, by utilizing this property, the swing detection section 79 is provided on the lower surface of the main board 50. This eliminates the need for the dedicated main board 50 for providing the swing detection section 79, and thus an increase in the cost of the device can be suppressed, and an increase in the size of the device can also be suppressed.

In the present embodiment, the distance Wy1 between the first side E1 and the second side E2 of the main board 50 is longer than the vertical length of the first frame surface 40b, that is, the length of the range Wz1 in FIG. 8B, so the dimensions of the main board 50 can be secured.

However, the distance Wy1 may be equal to or shorter than the vertical length of the first frame surface 40b.

In the embodiment, the printer 1 includes a scanner section 3 which reads an image of a document on the upper portion of the main frame 40. In the configuration in which the scanner section 3 is provided on the upper portion of the main frame 40, the dimension of the device in the height direction is likely to increase, but the dimension of the device in the height direction can be suppressed by disposing the main board 50 as described above.

The present disclosure is not limited to the embodiments and modifications described above, various modifications are possible within the scope of the disclosure described in the claims, it is needless to say that they are also included in the scope of the present disclosure.

What is claimed is:

1. A recording device comprising:
a medium support section that supports a medium before feeding in an inclined posture;
a feed roller that feeds the medium from the medium support section;
a recording section that performs recording on the medium fed by the feed roller;
a frame positioned between the medium support section and the recording section; and
a board on which an electronic component is mounted, wherein
the frame has a first frame surface facing the feed roller and a second frame surface opposite from the first frame surface,
the second frame surface faces the recording section,
the board has a first side and a second side opposite from the first side, and
the board is disposed such that the first side faces the first frame surface of the frame and the second side is farther from the frame than the first side in a direction intersecting the first frame surface.

2. The recording device according to claim 1, wherein
the board is disposed in a posture along a horizontal plane.

3. The recording device according to claim 1, wherein
the board is disposed at a position that is above the feed roller and that overlaps the feed roller in plan view.

4. The recording device according to claim 1, wherein
the board includes a connector connection section on a surface facing upward.

5. The recording device according to claim 1, further comprising:
a shield plate on an underside of the board, wherein
the frame includes a frame fixing section that protrudes from the first frame surface toward the medium support section,
the shield plate is fixed to the frame fixing section from above with screws, and
the board is fixed to the shield plate from above with screws in a state of being placed on the shield plate.

6. The recording device according to claim 5, further comprising:
a passage detection section that detects passage of a medium downstream of the feed roller in a medium transport path, wherein
the passage detection section includes
a lever that swings by contact with medium and
a lever detection section that detects a change in posture of the lever,
the lever is swingably supported by a holder member fixed to the first frame surface of the frame,
the lever detection section is provided on a lower surface of the board, and
the holder member supports the shield plate.

7. The recording device according to claim 6, wherein
the shield plate is fixed to the holder member from above with screws.

8. The recording device according to claim 6, further comprising:
a medium detection section that detects presence or absence of a medium on the medium support section, wherein
the medium detection section includes
a swing section that swings in contact with the medium placed on the medium support section and
a swing detection section that detects a change in the posture of the swing section,
the swing section is swingably supported by the holder member, and
the swing detection section is provided on a lower surface of the board.

9. The recording device according to claim 1, wherein
a distance between the first side and the second side of the board is longer than a length of the first frame surface in a vertical direction.

10. The recording device according to claim 1, further comprising:
an image reading section that reads an image of a document is provided on an upper portion of the frame.
